(19) United States
(12) Patent Application Publication
(10) Pub. No.: US 2004/0099138 A1
(43) Pub. Date: May 27, 2004

(54) Membrane separation process

(75) Inventors: Sandeep K. Karode, Boothwyn, PA (US); Charles L. Anderson, Wilmington (DE)

Correspondence Address: JEFFREY C. LEW, 2205 SILVERSIDE ROAD, WILMINGTON, DE, 19810, US

(73) Assignee: L'Air Liquide, Societe Anonyme A Directoire et Conseil De Surveillance Pour L'Etude et, Paris (FR)

(21) Appl. No.: 10/712,752

(22) Filed: Nov. 13, 2003

Related U.S. Application Data
(60) Provisional application No. 60/428,047, filed on Nov. 21, 2002.

(51) Int. Cl. B01D 53/14; B01D 53/22

(52) U.S. Cl. 95/214; 95/51; 95/231; 95/237

(57) ABSTRACT

A high purity stream of methane can be obtained from crude natural gas, especially exhaust gas from waste landfills, by a process that includes first removing moisture, then feeding the dried crude gas mixture to a gas-liquid contact absorber to strip heavy hydrocarbon compounds in a primarily carbon dioxide by product stream. Methane enriched gas from the absorber is separated in a membrane separation unit which provides permeate enriched in carbon dioxide that is recycled to the absorber and a purified product stream of methane.

### FIELD OF THE INVENTION

This invention relates to a membrane separation process for refining natural gas. More specifically it pertains to a process involving treatment of raw gas feed by absorption to remove heavy hydrocarbon contaminants prior to using membrane separation unit operations for separating methane from carbon dioxide.

### BACKGROUND OF THE INVENTION

Refined natural gas, i.e. typically about 97 mole percent methane, about 3 mole % carbon dioxide and trace amounts of water vapor, is an important commercial commodity for uses such as high heating value fuel and feedstock for chemical production processes. Crude natural gas, that is, methane mixed with contaminants, is available from various sources such as ground wells. Exhaust gas from solid waste landfills is also becoming an ever increasingly valued source of crude methane. Such raw gases typically contain between 10-50 mole % carbon dioxide, 50-80 mole % methane and a few percent of contaminants including heavy hydrocarbons. Carbon dioxide can be used in food processing and other applications. Raw natural gas mixtures can thus provide two valuable industrial materials, namely methane and carbon dioxide.

Membrane separation is a very effective method for separating methane from carbon dioxide. However, the separation performance of selectively gas permeable membranes is usually adversely affected by the contaminants, especially the heavy hydrocarbons, present in crude gas mixtures. Thus for a viable membrane separation of methane, there is a need to remove the heavy hydrocarbons. Furthermore, natural gas with heavy hydrogen contamination is not commercially practical to transport from the source to the consumer. Consequently, so-called “pipeline specifications” for the quality of refined natural gas have low concentration limits for heavy hydrocarbons. The removal of heavy hydrocarbons from mixtures of carbon dioxide and methane is also desirable for this reason. Some approaches for stripping hydrocarbons from crude natural gas such that membrane separation of methane and carbon dioxide can follow have utilized such unit operations as dew point control (“DPC”), temperature swing adsorption (“TSA”) and pressure swing adsorption (“PSA”) as major elements of the methane concentrating process. Broadly stated, DPC, TSA and PSA respectively require significant amounts of refrigeration, steam and clean gas to function effectively. These auxiliary utilities are expensive and thus add appreciably to the cost of the product.

Membrane separation often performs at greatest efficiency when the feed is pressurized. The cost of compression can lower the economic justification for such a process. Additionally, membrane separation usually involves multiple stages, i.e., more than one membrane separation unit in a series, to achieve a desirably pure methane product concentration. Multiple stages can generate potentially wasteful byproduct streams that further reduce the attractiveness of membrane separation to refine methane. Primarily for these reasons, membrane separation processes have not heretofore found great favor for commercially producing methane from landfill exhaust gas.

An interesting process for concentrating and recovering methane and carbon dioxide from landfill gas is disclosed in U.S. Pat. No. 5,681,360, assigned to Acrion Technologies, Inc. The “Acrion” process incorporates absorbing commonly occurring pollutants of landfill gas in one or two vessels with a relatively small proportion of the carbon dioxide absorbent present in the gas. This process produces a methane enriched stream and a carbon dioxide enriched stream. The methane enriched stream contains a small but significant fraction of carbon dioxide that remains to be separated to provide a refined methane product. The carbon dioxide enriched stream contains an amount of methane that is wasted, and may need additional methane to facilitate disposal by flaring.

It is desirable to have an integrated, cost and energy efficient process that yields a highly concentrated methane composition from a crude natural gas with a reduced loss of methane in the waste.

### SUMMARY OF THE INVENTION

A very effective process and system for refining methane from crude natural gas has been discovered. The novel process and system features a preliminary absorption of heavy hydrocarbon compounds with a carbon dioxide absorbent, followed by membrane separation of the methane enriched absorption product. Significantly, the permeate gas from the downstream primary membrane separation unit operation is returned to supply absorbent to the upstream absorption operation. In a preferred, multi-stage membrane separation embodiment, the permeate gas from second and optional higher order membrane stages is recycled to the absorption unit feed thereby providing for highly efficient recovery of raw materials.

Accordingly, the present invention provides a process for separating methane from a crude gas mixture comprising methane, carbon dioxide and heavy hydrocarbon compounds, the process comprising absorbing the heavy hydrocarbon compounds from the crude gas mixture with a carbon dioxide enriched composition to provide an intermediate gas mixture substantially free of heavy hydrocarbon compounds, separating the intermediate gas mixture with a selectively gas permeable membrane to form (a) a methane enriched product mixture and (b) the carbon dioxide enriched composition, and using the carbon dioxide enriched composition thus obtained for absorbing the heavy hydrocarbon compounds from the crude gas mixture. The invention also provides a process for separating methane from a crude mixture comprising methane, carbon dioxide and hydrocarbon compounds, the process comprising the steps of

(A) compressing the crude gas mixture and removing water therefrom to produce a dehydrated feed gas comprising the methane, carbon dioxide and heavy hydrocarbon compounds,

(B) contacting in an absorber unit the feed gas with liquid absorbent condensed from a first stage permeate gas mixture comprising a major fraction of carbon dioxide, and substantially completely absorbing into the absorbent the heavy hydrocarbon compounds to form a liquid byproduct comprising carbon dioxide and heavy hydrocarbon compounds.

(C) separately removing from the absorber unit the liquid byproduct and an intermediate gas mixture comprising methane and carbon dioxide and which is substantially free of heavy hydrocarbon compounds,

(D) contacting in a first stage membrane separation unit the intermediate gas mixture with a feed side of a first membrane that is preferentially permeable for carbon dioxide relative to methane and causing the intermediate gas mixture to selectively permeate through the membrane to form said first stage permeate gas mixture on a permeate side of the membrane, and

(E) removing from the feed side of the membrane of the first stage membrane separation unit a first stage retentate gas mixture enriched in methane relative to the intermediate gas mixture.

The invention further provides a system for producing refined methane from a crude mixture comprising methane, carbon dioxide and volatile organic compounds, the system comprising

(a) a dryer operative to remove water from the crude mixture and a compressor operative to increase pressure of the crude mixture to a pressure suitable for absorbing the heavy hydrocarbons,

(b) a counter-flow gas-liquid direct contact absorber downstream of the dryer and compressor and adapted to substantially completely absorb the heavy hydrocarbon compounds from the crude mixture into a liquid carbon dioxide absorbent and adapted to produce an intermediate gas mixture substantially free of heavy hydrocarbon compounds in a single pass,

(c) a first stage membrane separation unit having a first membrane that is preferentially permeable for carbon dioxide relative to methane, a feed chamber on one side of the membrane in fluid communication with the intermediate gas mixture, and a permeate chamber on a side of the first membrane opposite the feed chamber and which is adapted to receive a first stage permeate gas of intermediate gas mixture selectively permeated through the first membrane,

(d) a condenser operative to liquefy the first stage permeate gas, and

(e) a recycle transfer line in fluid communication between the absorber and the permeate chamber of the first stage membrane separation unit which is operative to transport the first stage permeate gas into the absorber.

### BRIEF DESCRIPTION OF THE DRAWINGS

FIG. 1 is a schematic flow diagram of an embodiment of the present invention.

### DETAILED DESCRIPTION OF THE INVENTION

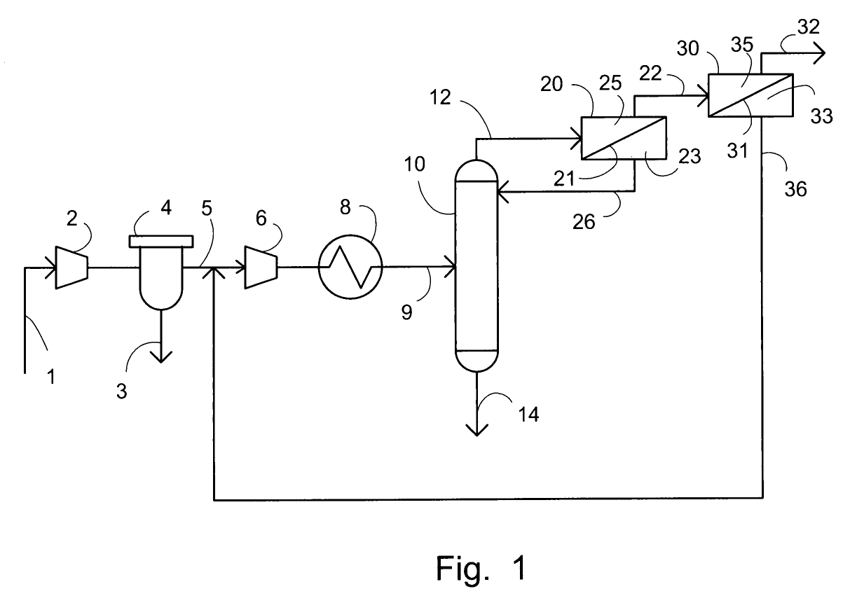

With reference to FIG. 1 it is seen that in an embodiment of the present invention a crude natural gas stream 1 is processed to produce a refined methane stream 32. The crude natural gas comprises largely methane and carbon dioxide and includes various contaminants in minor amounts such as oxygen, nitrogen, hydrogen sulfide, water, and hydrocarbons other than methane. The crude gas is pre-treated to remove water. This is performed by compressing the gas in compressor 2 and dried in dryer 4. The dryer can be any type of dehumidifier well known in the art, such as a chilled coil coalescing filter. Typically, water is removed in a condensed liquid stream 3.

The dehydrated crude gas stream 5 is then conditioned for absorption removal of heavy hydrocarbon compounds. Conditioning is accomplished in compressor 6 and heat exchanger 8, which respectively increase the pressure and temperature of the absorber feed gas 9 to values favorable for removing the hydrocarbons.

The conditioned absorber feed gas 9 is fed into an absorption vessel 10. Again, any conventional apparatus adapted to carry out gas-liquid contact absorption can be used. Preferably, the absorption unit is a vertically oriented column. Such columns are typically filled with packing particles or are equipped with sieve plates or bubble cap trays as used in the industry for fractionating fluid mixtures. The feed gas is usually introduced between the top and bottom, preferably from near the bottom to mid-height of the absorber and a gas stream 12 depleted of heavy hydrocarbons but having significant amount of methane is taken from the top. An absorbent stream 26 is made to flow into the column between the top and bottom and above the introduction point of the feed gas. Preferably the absorbent stream is charged near the top of the absorber as represented in the FIG. 1. The absorbent stream 26 is a composition rich in carbon dioxide. This stream can be condensed, for example, by an in-line condenser unit, an external reflux condenser for the column, or an internal condensing heat exchanger within the top of the column. The carbon dioxide flows downward through the absorption column 10, absorbs heavy hydrocarbons from the feed stock, and discharges as byproduct stream 14 from the bottom of the column.

The heavy hydrocarbon-depleted overhead product 12 passes into a first stage membrane separation unit 20. An optional compressor, not shown, can be used to convey this stream into separation unit 20. This intermediate gas mixture is substantially free of heavy hydrocarbon compounds that might otherwise be harmful to the membrane or adversely affect membrane separation performance. The terms “substantially” and “substantially completely” are used in present context and elsewhere herein to mean that the related property exists largely although not absolutely or wholly. For example, “substantially free of heavy hydrocarbon compounds” means that the gas mixture is largely devoid of those hydrocarbons but not necessarily wholly free of inconsequential concentrations thereof.

Membrane separators known in the art can be used. The separation unit for this invention is characterized by having a selectively gas permeable membrane 21 that is preferentially permeable for carbon dioxide relative to methane. That is, carbon dioxide permeates the membrane faster than methane. The membrane 21 has two sides which divide the separation unit into a feed chamber 25 and a permeate chamber 23. The intermediate gas mixture 12 coming in contact with membrane 21 permeates into the permeate chamber. There it is withdrawn and returned to the absorption column as first stage permeate gas mixture 26. The first stage permeate gas mixture is enriched in carbon dioxide and thus is ideal to serve as the absorbent fluid in the absorber column.

The retentate gas mixture on the feed chamber side of membrane 21 is depleted in carbon dioxide by virtue of the membrane separation process and accordingly is enriched in methane. For some product applications, the concentration of methane in the first stage retentate gas mixture may be satisfactory. In such case, the first stage retentate gas mixture can be stored or used directly in a subsequent process unit operation. Normally, refined methane for high heat value fuel utility should have a higher concentration of methane and fewer contaminants than can be provided by a single stage membrane separation. For such purpose, a second stage membrane separation can be performed.

The first stage retentate gas mixture 22 can be transported into a feed chamber 35 of a second stage membrane separation unit 30. Second stage permeate chamber 33 is on the opposite side of second membrane 31 which also is preferentially permeable for carbon dioxide relative to methane. Due to contact of the first stage retentate gas mixture with the second membrane, the gas selectively permeates to form a carbon dioxide rich second stage permeate gas mixture 36 and provides a highly methane enriched second stage retentate gas mixture 32. This highly methane enriched gas mixture usually is of sufficiently high concentration of methane to be utilized as a heat value fuel and thus can be withdrawn from the second stage membrane separation unit to storage facilities or directly to a combustion process for conversion to thermal energy.

The second stage permeate gas mixture 36 is predominantly concentrated in carbon dioxide and contains some methane that permeates the second membrane. To recover the methane, the second stage permeate gas 36 is recycled through the membrane separation units. The second stage permeate gas is usually at too low a pressure to directly feed into the absorber column with the first stage permeate gas 26. While the second stage permeate could be recycled into the crude feed gas 1, it is already dried. Therefore, the second stage permeate is preferably fed back into the dried crude gas mixture 5 upstream of compressor 6 as shown in FIG. 1.

The composition of the raw gas feed to the refining process can be variable and depends upon source of crude natural gas. By way of example, a crude gas mixture typically contains about 30 vol. % carbon dioxide, 60 vol. % methane and about 10 vol. % of other contaminants including hydrogen sulfide, water, oxygen, nitrogen and hydrocarbon compounds other than methane. The other hydrocarbons can be categorized a being either “light hydrocarbon compounds” or “heavy hydrocarbon compounds”. As used herein, the term “heavy hydrocarbon compounds” means chemical compounds formed exclusively of hydrogen and carbon and having more than 6 carbon atoms. Heavy hydrocarbons usually enter and occlude the pores of selectively gas permeable membranes, a phenomenon sometimes referred to as “plasticizing”. Plasticizing can adversely affect the separation performance of the membranes, usually, to the extent that membrane separation of the components becomes practically infeasible.

In a typical embodiment of this invention the crude gas mixture is compressed to about 2.1 MPa (300 psi) and dried in a coalescing water filter to remove substantially all of the water. The dried crude gas mixture is compressed to about 6.0 MPa (870 psi) and heated in a fin tube heat exchanger to about 35° C. prior to being introduced at about mid-height in a packed absorber column. The absorber usually operates at about 5.5-7.6 MPa (800-1100 psi). This pressure range makes the novel method ideal for refining methane from crude gas from natural sources, i.e., wells in natural subterranean geologic formations. These sources typically provide the crude gas at high pressures not very far below absorber operating pressures. Efficiency of the process is thus increased by the fact that only slight energy input is needed to compress the crude gas to operating pressure. The novel absorption process is capable of refining crude gas from disposed waste landfills, however, these sources produce the crude gas at much lower pressure. Substantial energy input is normally required to boost landfill exhaust gas to absorber operating pressure. This renders the novel process less preferred for treating waste landfill exhaust gas.

The crude gas mixture is counter-flow contacted in the absorber with carbon dioxide rich absorbant to provide an overhead stream comprising about 45 vol. % methane, 50 vol. % carbon dioxide and about 5 vol. % of contaminants including hydrogen sulfide, oxygen, nitrogen and light hydrocarbon compounds. The absorbent is condensed by cooling the top of the column to about −5° C. from which it descends as a liquid through the column. In contrast to other counter-flow fractionation processes, absorption of the heavy hydrocarbons into the absorbent is largely a single pass operation. That is, the crude gas flows upward from the point of entry into the absorber and the absorbent flows downward from point of entry. As the two streams contact each other, the heavy hydrocarbons are stripped from the crude and exit with the absorbent at the bottom. The bottom product is a liquid stream comprising about 97 vol. % carbon dioxide and about 3 vol. % heavy hydrocarbon compounds. Substantially all of the heavy hydrocarbon compounds are discharged in the absorber column bottom product.

As the crude gas continues upward through the absorber it contains less and less heavy hydrocarbons. At the top, the gas is substantially free of heavy hydrocarbon compounds and it discharges from the absorber as overhead gas. The overhead gas from the absorber column is admitted into the feed end of a first hollow fiber membrane module. The permeate gas mixture has a composition of about 90 vol. % carbon dioxide and about 10 vol. % of methane and contaminants including light hydrocarbon compounds. This gas mixture is compressed, cooled and returned from the first membrane module to the top of the absorber column where it is contacted with the upflowing gas.

An advantageous feature of the novel process derives from the high pressure, i.e., usually above 5.5 MPa (800 psi) at which absorption of the heavy hydrocarbon compounds in the absorber occurs. After the first stage permeate gas is compressed to a suitable high pressure to permit return to the absorber, it can be condensed to the liquid state using a medium of merely mild cooling temperature. For example, brine or water in the temperature range of about −5 to about 20° C. can be used to liquefy carbon dioxide at high pressure. In comparison, fractional distillation of hydrocarbon-carbon dioxide at lower pressures usually requires reflux condensation at much lower temperatures that demand the use of more costly and difficult to operate cryogenic cooling units with coolant temperatures below about −50° C.

After contacting the feed side of the first membrane, gas is removed from the first stage membrane separation unit. This first stage retentate gas mixture has a composition of about 60 vol. % methane, about 30 vol. % carbon dioxide and the balance comprising light hydrocarbons other than methane, water, oxygen, and nitrogen.

The first stage retentate gas mixture is charged into a second gas separation membrane unit such that it contacts one side of a second selectively permeable membrane. The second stage permeate gas mixture composition is a composition of about 62 vol. % carbon dioxide and about 35 vol. % methane. Although the quantity of methane in the permeate is small, it is worth capturing. Thus the second stage permeate gas mixture is recycled into the dried crude gas. The retentate gas mixture from the second stage separation unit has a composition of about 98 vol. % methane, light hydrocarbon compounds, and about 2 vol. % carbon dioxide. This mixture is suitable for industrial use, primarily for heat value by burning as a fuel.

The membrane separation units that can be used in this invention are well known in the art. The primary element of such membrane separation units is a selectively gas permeable membrane. Typically these are of polymeric composition.

A wide range of polymeric materials have desirable selectively gas permeating properties and can be for the membrane in the present invention. Representative materials include polyamides, polyimides, polyesters, polycarbonates, copolycarbonate esters, polyethers, polyetherketones, polyetherimides, polyethersulfones, polysulfones, fluorine-substituted ethylene polymers and copolymers such as polyvinylidene fluoride, tetrafluoroethylene, copolymers of tetrafluorethylene with perfluorovinylethers or with perfluorodioxoles, polybenzimidazoles, polybenzoxazoles, polyacrylonitrile, cellulosic derivatives, polyazoaromatics, poly(2,6-dimethylphenylene oxide), polyphenylene oxide, polyureas, polyurethanes, polyhydrazides, polyazomethines, polyacetals, cellulose acetates, cellulose nitrates, ethyl cellulose, styrene-acrylonitrile copolymers, brominated poly(xylylene oxide), sulfonated poly(xylylene oxide), tetrahalogen-substituted polycarbonates, tetrahalogen-substituted polyesters, tetrahalogen-substituted polycarbonate esters, polyquinoxaline, polyamideimides, polyamide esters, blends thereof, copolymers thereof, substituted materials thereof, and the like. Other likely suitable gas separating layer membrane materials can include polysiloxanes, polyacetylenes, polyphosphazenes, polyethylenes, poly(4-methylpentene), poly(trimethylsilylpropyne), poly(trialkylsilylacetylenes), polyureas, polyurethanes, blends thereof, copolymers thereof, substituted materials thereof, and the like. It is further anticipated that polymerizable substances, that is, materials which cure to form a polymer, such as vulcanizable siloxanes and the like, may be suitable gas separating layers for the multicomponent gas separation membranes of the present invention. Preferred materials for the dense gas separating layer include aromatic polyamide and aromatic polyimide compositions.

The membrane can have many forms such as flat sheet, pleated sheet, spiral wound, tube, ribbon tube and hollow fiber, to name a few. The membranes may be mounted in any convenient type of housing or vessel adapted to provide a supply of the feed gas, and removal of the permeate and residue gas. The vessel also provides a high-pressure side (for the feed gas and residue gas) and a low-pressure side of the membrane (for the permeate gas). For example, flat-sheet membranes can be stacked in plate-and-frame modules or wound in spiral-wound modules. A large number of hollow fiber membranes can be assembled in a bundle of a membrane module typically potted with a thermoset resin in a cylindrical housing and having a parallel flow configuration through the fiber bundle. Hollow fiber modules are often preferred in view that they provide a large membrane surface in a small volume. The final membrane separation unit comprises one or more membrane modules, which may be housed individually in pressure vessels or multiple elements may be mounted together in a sealed housing of appropriate diameter and length.

For improved performance hollow fiber membranes usually comprise a very thin selective layer that forms part of a thicker structure. This may be, for example, an integral asymmetric membrane, comprising a dense skin region that forms the selective layer and a micro-porous support region. Such membranes are described, for example, in U.S. Pat. No. 5,015,270 to Ekiner. By way of a further, and preferred example, the hollow fiber membrane can be a so-called “composite membrane” type, that is, a membrane having multiple layers. Composite membranes typically comprise a porous but non-selective support membrane, which provides mechanical strength, coated with a thin selective layer of another material that is primarily responsible for the separation properties. A diverse variety of polymers can be used for the substrate. Representative support membrane materials include polysulfone, polyethersulfone, polyetherimide, polyimide and polyamide compositions blends thereof, copolymers thereof, substituted materials thereof and the like. Typically, such a composite membrane is made by solution-casting (or spinning in the case of hollow fibers) the support membrane, then solution-coating the selective layer in a separate step. Hollow-fiber composite membranes also can be made by co-extrusion spinning of both the support material and the separating layer simultaneously as described in U.S. Pat. No. 5,085,676 to Ekiner. The entire disclosures of the aforementioned patents are hereby incorporated herein. Membrane separation units for use in the present invention are available from the MEDAL unit of Air Liquide, S.A., Houston, Tex.

Although specific forms of the invention have been selected in the preceding disclosure for illustration in specific terms for the purpose of describing these forms of the invention fully and amply for one of average skill in the pertinent art, it should be understood that various substitutions and modifications which bring about substantially equivalent or superior results and/or performance are deemed to be within the scope and spirit of the following claims.

What is claimed is:

1. A process for separating methane from a crude gas mixture comprising methane, carbon dioxide and heavy hydrocarbon compounds, the process comprising absorbing the heavy hydrocarbon compounds from the crude gas mixture with a carbon dioxide enriched composition to provide an intermediate gas mixture substantially free of heavy hydrocarbon compounds, separating the intermediate gas mixture with a selectively gas permeable membrane to form (a) a methane enriched product mixture and (b) the carbon dioxide enriched composition, and using the carbon dioxide enriched composition thus obtained for absorbing the heavy hydrocarbon compounds from the crude gas mixture.

2. A process for separating methane from a crude mixture comprising methane, carbon dioxide and hydrocarbon compounds, the process comprising the steps of
(A) compressing the crude gas mixture and removing water therefrom to produce a dehydrated feed gas comprising the methane, carbon dioxide and heavy hydrocarbon compounds,
(B) contacting in an absorber unit the feed gas with liquid absorbent condensed from a first stage permeate gas mixture comprising a major fraction of carbon dioxide, and substantially completely absorbing into the absorbent the heavy hydrocarbon compounds to form a liquid byproduct comprising carbon dioxide and heavy hydrocarbon compounds.
(C) separately removing from the absorber unit the liquid byproduct and an intermediate gas mixture comprising methane and carbon dioxide and which is substantially free of heavy hydrocarbon compounds,
(D) contacting in a first stage membrane separation unit the intermediate gas mixture with a feed side of a first membrane that is preferentially permeable for carbon dioxide relative to methane and causing the intermediate gas mixture to selectively permeate through the membrane to form said first stage permeate gas mixture on a permeate side of the membrane, and
(E) removing from the feed side of the membrane of the first stage membrane separation unit a first stage retentate gas mixture enriched in methane relative to the intermediate gas mixture.

3. The process of claim 2 in which the heavy hydrocarbon compounds are absorbed into the absorbent in a single pass through the absorption unit.

4. The process of claim 2 in which absorbing of the heavy hydrocarbon compounds into the absorbent occurs at a pressure greater than about 5.5 MPa (800 psi).

5. The process of claim 2 which further comprises
(F) contacting in a second stage membrane separation unit the first stage retentate gas mixture with a feed side of a second membrane that is preferentially permeable for carbon dioxide relative to methane and causing the first stage retentate gas mixture to selectively permeate through the second membrane to form a second stage permeate gas mixture, and
(G) removing from the second stage membrane separation unit a second stage retentate gas mixture enriched in methane relative to the first stage retentate gas mixtures.

6. The process of claim 5 which further comprises feeding the second stage permeate gas mixture into the dehydrated feed gas.

7. The process of claim 2 in which the step of contacting and absorbing comprises
(B-1) introducing the dehydrated feed gas into a vertically oriented, counter-current gas-liquid absorption column at a feed point of the column,
(B-2) condensing at least a major fraction of the carbon dioxide of the first stage permeate gas mixture to form a liquid carbon dioxide absorbent,
(B-3) feeding the liquid carbon dioxide absorbent into the absorption column above the feed point, and
(B-4) draining the byproduct from the absorption column.

8. The process of claim 7 in which condensing of the carbon dioxide is carried out within the absorption column.

9. The process of claim 7 in which the feed point is at an elevation above the bottom and below mid-height of the absorption column.

10. The process of claim 2 which further comprises condensing the first stage permeate gas mixture with a cooling medium at a temperature greater than about −5° C.

11. A system for producing refined methane from a crude mixture comprising methane, carbon dioxide and volatile organic compounds, the system comprising
(a) a dryer operative to remove water from the crude mixture and a compressor operative to increase pressure of the crude mixture to a pressure suitable for absorbing the heavy hydrocarbons,
(b) a counter-flow gas-liquid direct contact absorber downstream of the dryer and compressor and adapted to substantially completely absorb the heavy hydrocarbon compounds from the crude mixture into a liquid carbon dioxide absorbent and adapted to produce an intermediate gas mixture substantially free of heavy hydrocarbon compounds in a single pass,
(c) a first stage membrane separation unit having a first membrane that is preferentially permeable for carbon dioxide relative to methane, a feed chamber on one side of the membrane in fluid communication with the intermediate gas mixture, and a permeate chamber on a side of the first membrane opposite the feed chamber and which is adapted to receive a first stage permeate gas of intermediate gas mixture selectively permeated through the first membrane,
(d) a condenser operative to liquefy the first stage permeate gas, and
(e) a recycle transfer line in fluid communication between the absorber and the permeate chamber of the first stage membrane separation unit which is operative to transport the first stage permeate gas into the absorber.

12. The system of claim 11 in which the feed chamber is adapted to receive a first stage retentate gas, the system further comprising
(f) a second stage membrane separation unit having a second membrane that is preferentially permeable for carbon dioxide relative to methane, a feed chamber on one side of the second membrane in fluid communication with the first stage retentate gas, and a permeate chamber on a side of the second membrane opposite the feed chamber and which is adapted to receive a second stage permeate gas of first stage retentate gas mixture selectively permeated through the second membrane, and
(g) a return transfer line in fluid communication between the permeate chamber of the second stage membrane separation unit and the crude mixture upstream of the absorber and being operative to feed the second stage permeate gas into compressed and dehydrated crude mixture.
